(19) United States
(12) Patent Application Publication
(10) Pub. No.: US 2025/0222712 A1
(43) Pub. Date: Jul. 10, 2025

(54) Reversible Book with Decodable Text

(71) Applicant: 95 Percent Group LLC, Lincolnshire, IL (US)

(72) Inventors: Jennifer Christine Harris, Scituate, MA (US); Joni Beryl Maville, Peoria, AZ (US)

(21) Appl. No.: 19/011,232

(22) Filed: Jan. 6, 2025

Related U.S. Application Data
(60) Provisional application No. 63/617,931, filed on Jan. 5, 2024.

(51) Int. Cl. B42D 1/00; G09B 17/00

(52) U.S. Cl. CPC B42D 1/009; B42D 1/001; G09B 17/00

(57) ABSTRACT

A reversible book is disclosed, the book comprising a plurality of pages, having a first configuration and a second configuration, where in the first configuration the plurality of pages includes a first text portion, and in the second configuration the plurality of pages includes a second text portion and an illustrated portion. The book further includes a binding fixing the plurality of pages in a predetermined order, where in the predetermined order the first text portion is readable when the book is in a first orientation, and the second text portion and illustrated portion are readable when the book is in a second orientation. In the example embodiment, the first text portion and the second text portion include decodable text.

### CROSS-REFERENCE TO RELATED APPLICATIONS

This application incorporates by reference in its entirety the disclosure of U.S. provisional application 63/617,931 filed on Jan. 5, 2024.

### BACKGROUND

Books designed to teach children how to read have evolved over centuries, with their primary goal being to foster literacy skills in young learners. Early educational books were often simple primers, such as the “hornbook” used in the 17th century, which featured the alphabet and basic prayers. Over time, reading instruction moved toward more structured formats, such as the “Dick and Jane” series in the 20th century, which emphasized repetitive vocabulary and simple sentence structures. These books were foundational in developing phonics-based and sight word recognition approaches. Today, children's reading materials include a variety of methods, from phonics-based readers that teach letter sounds and word-building to more engaging stories that use colorful illustrations to capture attention. Modern children's books often combine both phonics and whole-language methods to support a broad range of literacy development, aiming to build fluency, comprehension, and a love for reading. However, there is a need for improvements to children's books that foster literacy.

### SUMMARY

The present disclosure describes implementations that relate to a book containing a plurality of configurations and decodable text.

An example embodiment includes a book, the book including a plurality of pages, having a first configuration and a second configuration, where in the first configuration the plurality of pages includes a first text portion, and in the second configuration the plurality of pages includes a second text portion and an illustrated portion. The book can further include a binding fixing the plurality of pages in a predetermined order, where in the predetermined order the first text portion is readable when the book is in a first orientation, and the second text portion and illustrated portion are readable when the book is in a second orientation. In the example embodiment, the first text portion and the second text portion include decodable text.

A second example embodiment includes a plurality of books. Each book in the plurality of books can include a plurality of pages, having a first configuration and a second configuration, where in the first configuration the plurality of pages includes a first text portion, and in the second configuration the plurality of pages includes a second text portion and an illustrated portion. Each book can further include a binding fixing the plurality of pages in a predetermined order, where in the predetermined order the first text portion is readable when each book is in a first orientation, and the second text portion and illustrated portion are readable when each book is in a second orientation. In the example embodiment, the first text portion and the second text portion include decodable text.

The foregoing summary is illustrative only and is not intended to be in any way limiting. In addition to the illustrative aspects, implementations, and features described above, further aspects, implementations, and features will become apparent by reference to the drawings and the following detailed description.

### BRIEF DESCRIPTION OF THE DRAWINGS

FIG. 1A illustrates a book containing decodable text in a first configuration, according to an example embodiment.

FIG. 1B illustrates a book containing decodable text in a second configuration, according to an example embodiment.

FIG. 2A illustrates a cover of a book in a first configuration, according to an example embodiment.

FIG. 2B illustrates a page of a book in a first configuration, according to an example embodiment.

FIG. 2C illustrates a page of a book in a first configuration, according to an example embodiment.

FIG. 2D illustrates a page of a book in a first configuration, according to an example embodiment.

FIG. 2E illustrates a page of a book in a first configuration, according to an example embodiment.

FIG. 2F illustrates a page of a book in a first configuration, according to an example embodiment.

FIG. 2G illustrates a page of a book in a first configuration, according to an example embodiment.

FIG. 2H illustrates a page of a book in a first configuration, according to an example embodiment.

FIG. 2I illustrates a page of a book, according to an example embodiment.

FIG. 2J illustrates a page of a book in a second configuration, according to an example embodiment.

FIG. 2K illustrates a page of a book in a second configuration, according to an example embodiment.

FIG. 2L illustrates a page of a book in a second configuration, according to an example embodiment.

FIG. 2M illustrates a page of a book in a second configuration, according to an example embodiment.

FIG. 2N illustrates a page of a book in a second configuration, according to an example embodiment.

FIG. 2O illustrates a page of a book in a second configuration, according to an example embodiment.

FIG. 2P illustrates a page of a book in a second configuration, according to an example embodiment.

FIG. 2Q illustrates a page of a book in a second configuration, according to an example embodiment.

FIG. 2R illustrates a page of a book in a second configuration, according to an example embodiment.

FIG. 2S illustrates a page of a book in a second configuration, according to an example embodiment.

FIG. 2T illustrates a page of a book in a second configuration, according to an example embodiment.

FIG. 2U illustrates a page of a book in a second configuration, according to an example embodiment.

FIG. 2V illustrates a page of a book in a second configuration, according to an example embodiment.

FIG. 2W illustrates a page of a book in a second configuration, according to an example embodiment.

FIG. 2X illustrates a page of a book in a second configuration, according to an example embodiment.

FIG. 2Y illustrates a page of a book in a second configuration, according to an example embodiment.

FIG. 2Z illustrates an additional cover of a book in a second configuration, according to an example embodiment.

### DETAILED DESCRIPTION

Disclosed herein is a reversible book containing decodable text and methods for using the same.

The disclosed book includes a decodable story with text and illustrations, as well as a decodable story with text only. The decodable story with text only is accessible by positioning the book in a first orientation. The decodable story with text and illustrations is accessible by positioning the book in a second orientation. The disclosed book is designed to help students sharpen their decoding skills by reading the in the first orientation before reading in the second orientation. By reading the book in the first orientation before in the second orientation, the student reinforces effective decoding skills because the student must rely on sound-spelling knowledge to read the text without illustrations.

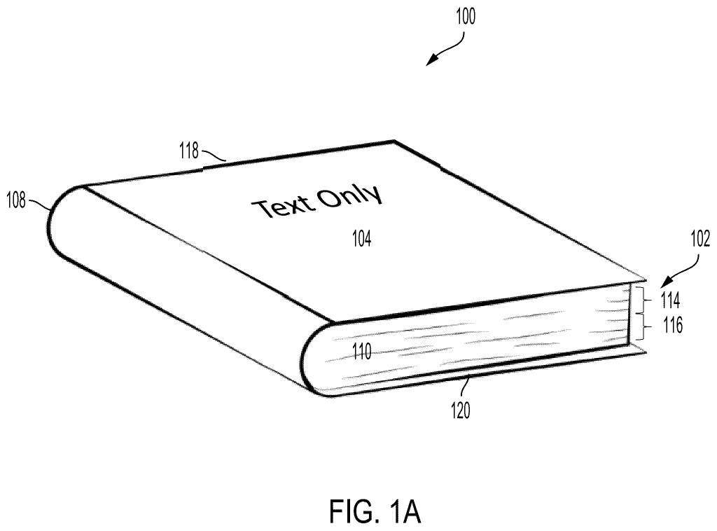

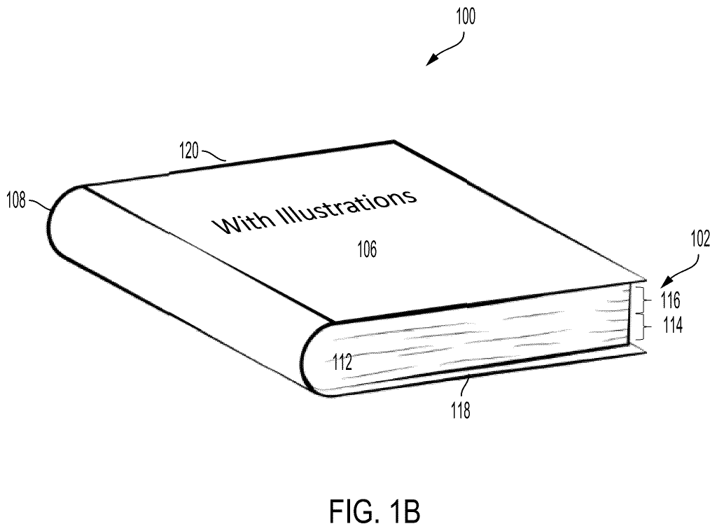

FIGS. 1A and 1B illustrate an example book 100. The book 100 can include a plurality of pages 102. The plurality of pages 102 can have a first configuration 104 and a second configuration 106. FIG. 1A illustrates the plurality of pages 102 in the first configuration 104. FIG. 1B illustrates the plurality of pages 102 in the second configuration 106. In the first configuration 104 the plurality of pages 102 can include a first text portion and in the second configuration 106 the plurality of pages can include a second text portion and an illustrated portion. The second text portion can include a plurality of sentences, and the illustrated portion can include a plurality of illustrations. Each illustration in the plurality of illustrations can correspond to at least one sentence in the plurality of sentences. Additionally, each illustration in the plurality of illustrations can convey an image. The image may be based on the corresponding at least one sentence in the plurality of sentences. For example, each illustration can depict what is happening in each sentence.

In an example embodiment, the first text portion is the same as the second text portion. For example, the text included in the first text portion may be identical to the text in the second text portion. The first text portion and the second text portion may be the same story. The story may be one suitable to help students sharpen their decoding skills. The story could be any length. In an example embodiment, the story may have a word count. The word count could be anywhere from 25 to 175 words.

The example book 100 can further include a bound edge 108. The bound edge 108 can fix the plurality of pages 102 in a predetermined order. In the predetermined order, the first text portion can be readable when the book 100 is in a first orientation 110 and the second text portion and illustrated portion can be readable when the book 100 is in a second orientation 112. FIG. 1A illustrates the book 100 in the first orientation 110 and FIG. 1B illustrates the book 100 in the second orientation 112.

In the book 100, the plurality of pages 102 can be separated into a first section of pages 114 and a second section of pages 116. The first section of pages 114 can be made up of the first text portion, and the second section of pages 116 can be made up of the second text portion and the illustrated portion. The first section of pages 114, which includes the first text portion, may be readable in the first configuration 104. The first configuration 104 may be related to the first orientation 110. The book 100 may be in the first configuration 104 and the first orientation 110 at the same time. The second section of pages 116, which includes the second text portion and the illustrated portion, may be readable in the second configuration 106. The second configuration 106 may be related to the second orientation 112. The book 100 may be in the second configuration 106 and the second orientation 112 at the same time.

Because the second section of pages 116 includes the second text portion as well as the illustrated portion, it may be longer than the first section of pages 114. For example, the first section of pages 114 may include a number of pages. The second section of pages 116 may also include a number of pages. The number of pages in the first section of pages 114 may be less than the number of pages in the second section of pages 116. The first section of pages 114 and the second section of pages 116 are bound together into the book 100.

In an example embodiment, the book 100 includes a first edge 118 and a second edge 120. In the first orientation 110, the first edge 118 is at a distal position from a reader and the second edge 120 is at a proximal position from the reader. For example, the first edge 118 may be the top of the book 100 and the second edge 120 may be the bottom of the book 100 relative to the reader. In the second orientation 112, the first edge 118 is at a proximal position from the reader and the second edge 120 is at a distal position from the reader. In the second orientation 112, the book 100 may be flipped over from top to bottom to read the second text portion and illustrated portion. For example, the first edge 118 may be the bottom of the book 100 and the second edge 120 may be the top of the book 100 relative to the reader.

In an example embodiment, the first text portion and the second text portion can be decodable text. In some embodiments, the disclosed book further includes a predetermined target phonics skill that aligns with the decodable text. Through reading the decodable text, the student practices or learns the predetermined target phonics skill. Decodable text can include a vowel (“V”) sound in various configurations with consonant (“C”) sounds.

In some embodiments, the predetermined target phonics skill includes at least one of a VC/CVC configuration including: short a/nasal a, short i, short o, short e, short u, or any combination thereof. In some embodiments, the predetermined phonics skill includes at least one of a CVC configuration including long a silent e, long i silent e, long o silent e, long e silent e, and long u silent e, or any combination thereof. In some embodiments, the predetermined target phonics skill includes at least one of short vowels, closed multisyllable, initial/final s-blends, initial/final 1-and-t-blends, initial r-blends, initial 3-letter-blends, consonant diagraphs ch/sh, consonant digraphs th/wh/ck, floss rules, and combinations of long vowels with silent-e, or any combination thereof.

In some embodiments, the disclosed book is part of a set of books, each book comprising a predetermined target phonics skill. In further embodiments, books within the set of books comprise the predetermined target phonics skills of at least one other book within the set of books.

An additional embodiment describes a system. The system includes a plurality of books. Each book in the plurality of books can be book 100 previously described. Each book in the plurality of books includes a plurality of pages. The plurality of pages can include a first configuration and a second configuration. In the first configuration the plurality of pages can include a first text portion and in the second configuration the plurality of pages can include a second text portion and an illustrated portion. Each book in the plurality of books can also include a bound edge fixing the plurality of pages in a predetermined order. In the predetermined order the first text portion is readable when the book is in a first orientation and the second text portion and illustrated portion is readable when the book is in a second orientation. The first text portion and the second text portion may be decodable text.

The plurality of books may be grouped together into a book set. Each book can contain coverage of a certain phonic skill or skills. In an example embodiment, the first text portion, the second text portion, and the illustrated portion in each of the plurality of books are different from each other the other books in the plurality of books. As a reader progresses through the set, the phonic skills can accumulate through the books. By the end of the set, the reader may see multiple phonic skills in one book.

In an example embodiment, each book in the plurality of books further includes a first edge and a second edge, as previously described. In the first orientation the first edge can be at a distal position from a reader and the second edge can be at a proximal position from the reader. In the second orientation the first edge can be at a proximal position from the reader and the second edge can be at a distal position from the reader.

In an example embodiment, in each book in the plurality of books the first text portion can be the same as the second text portion, as previously described. The first text portion and the second text portion can be a story. Each story can include a word count, which may be 25 to 175 words.

In an example embodiment, in each book in the plurality of books the second text portion can include a plurality of sentences, and the illustrated portion can include a plurality of illustrations. Each illustration in the plurality of illustrations can correspond to at least one sentence in the plurality of sentences.

In each book in the plurality of books the plurality of pages can include a first section of pages and a second section of pages. The first section of pages can include the first text portion, and the second section of pages can include the second text portion and the illustrated portion.

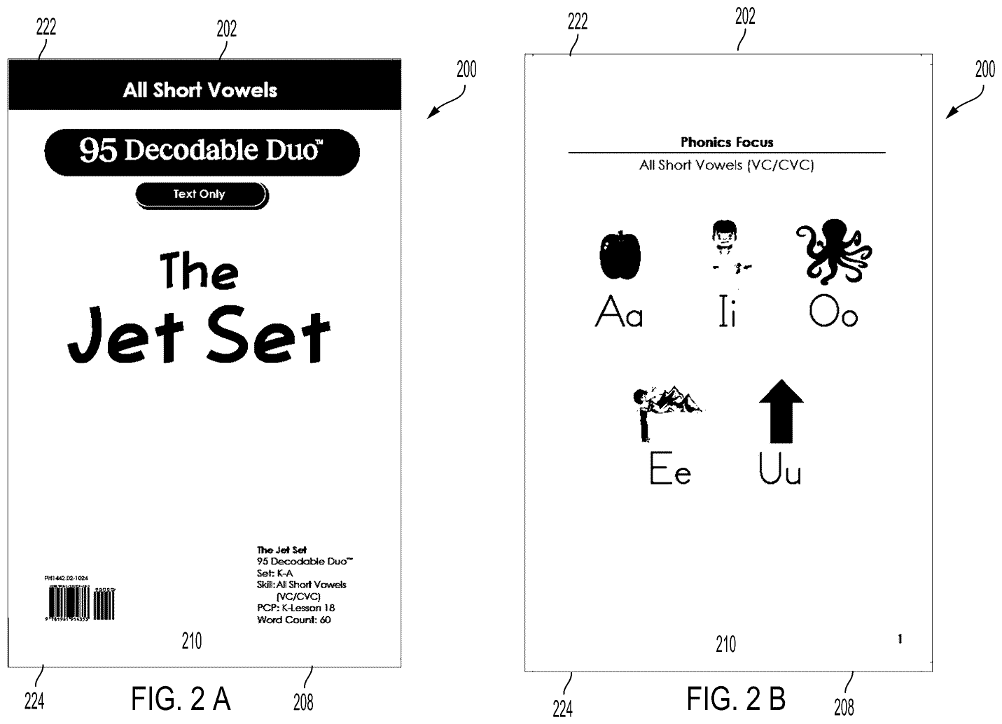

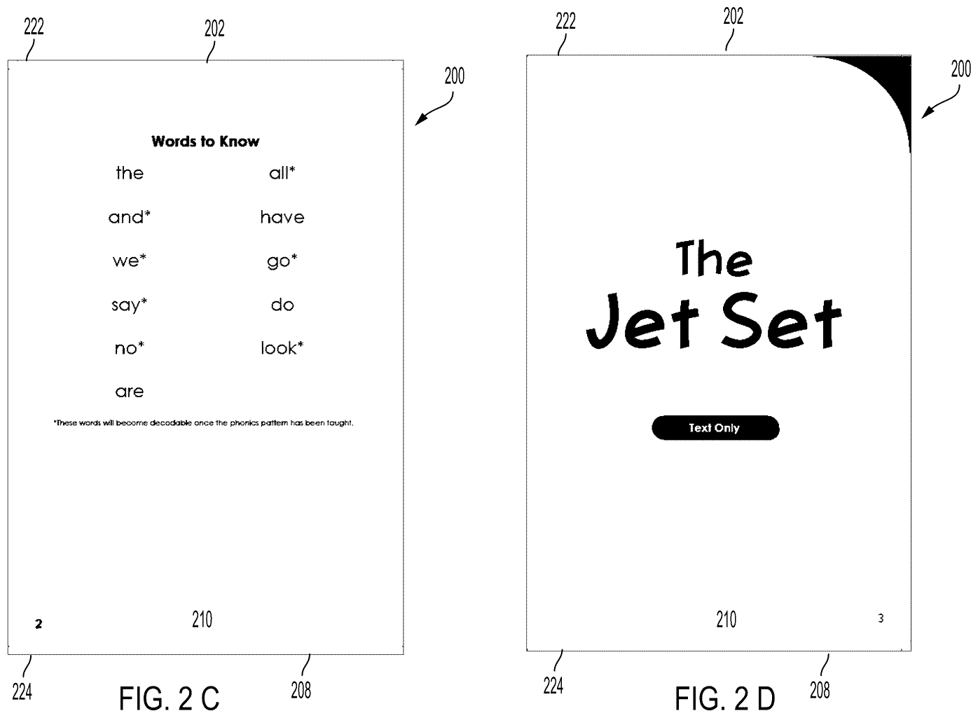

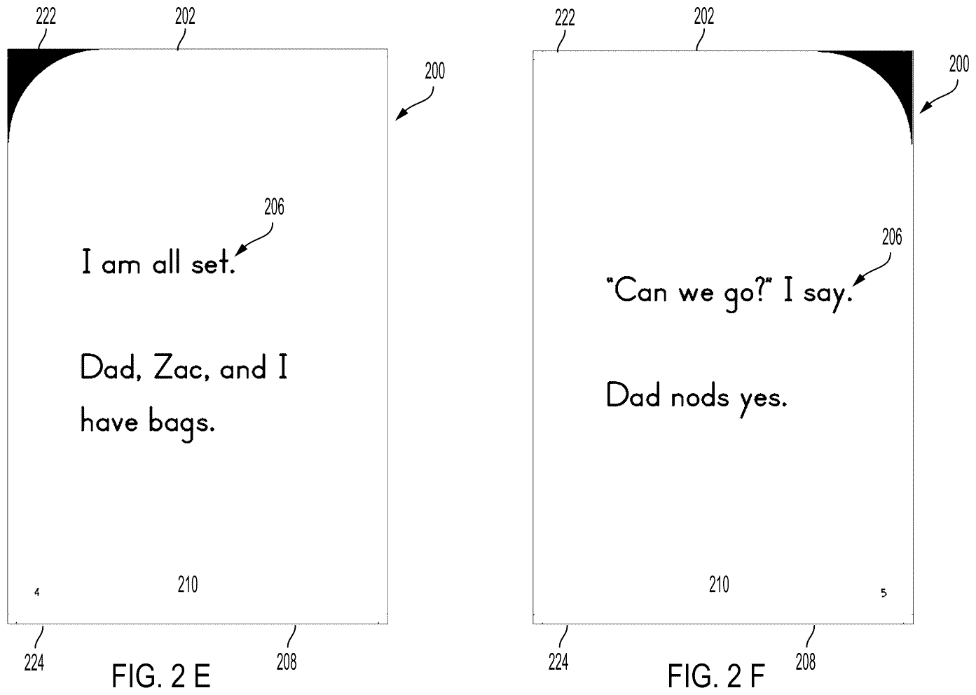

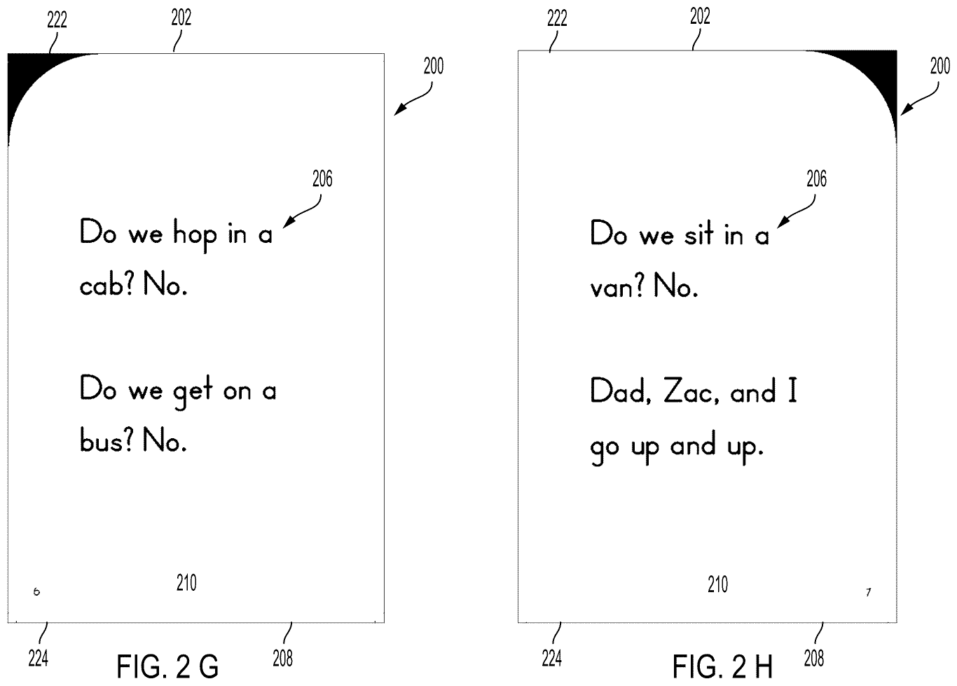

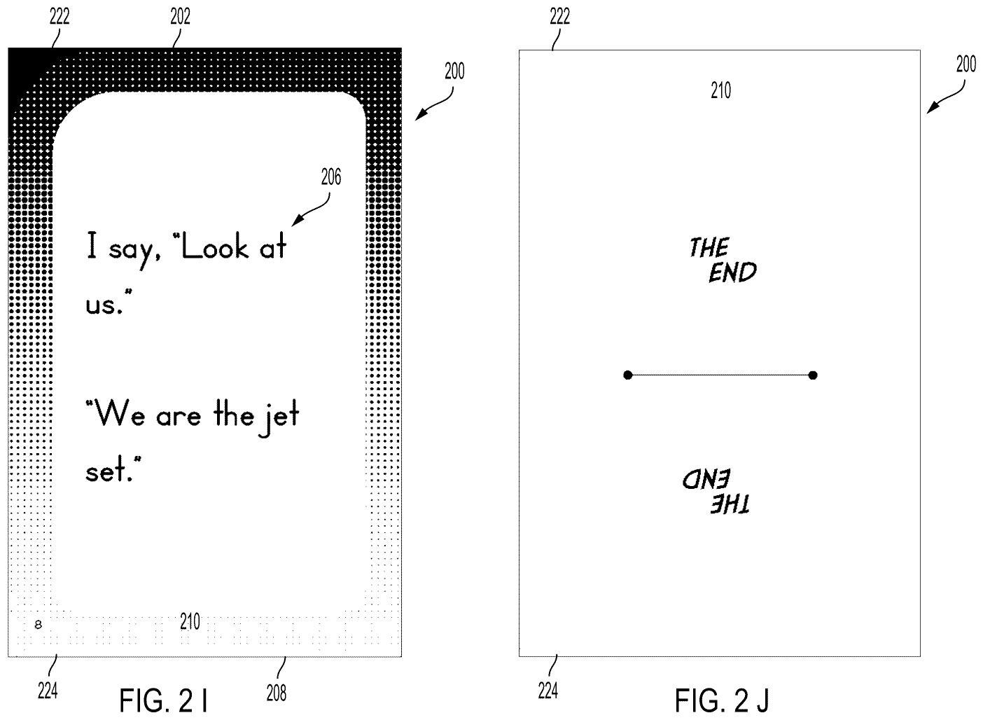

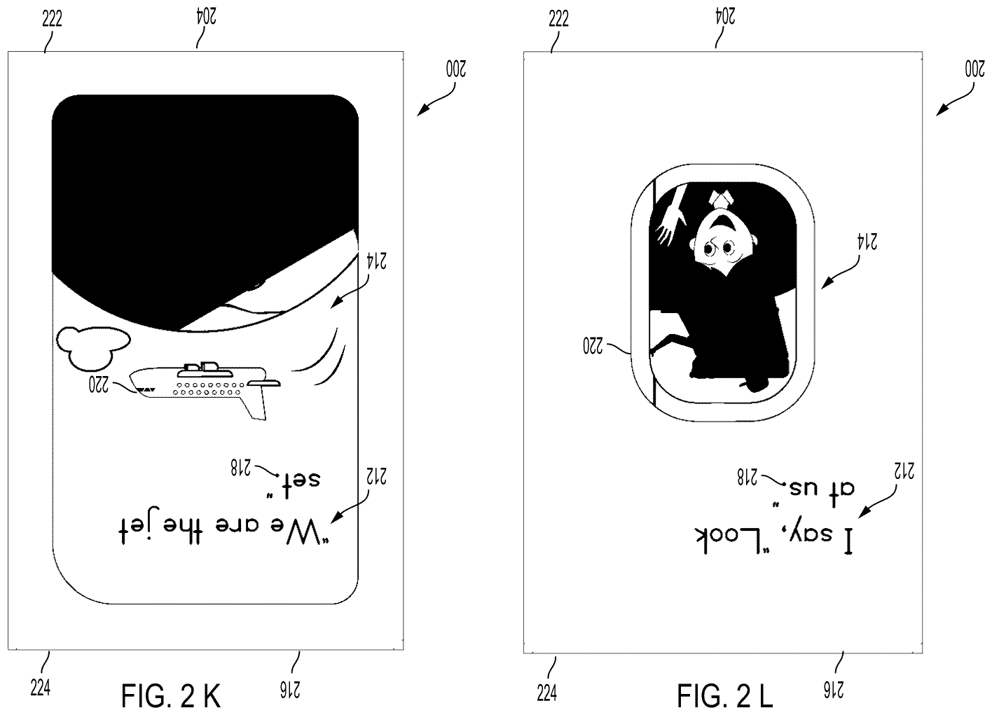

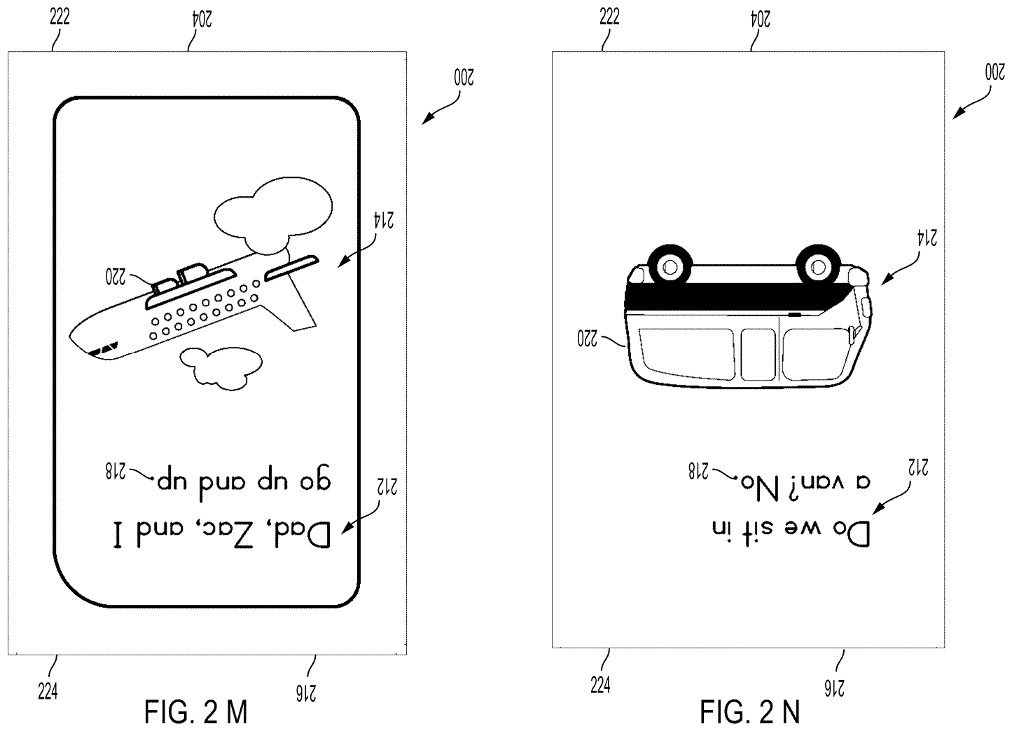

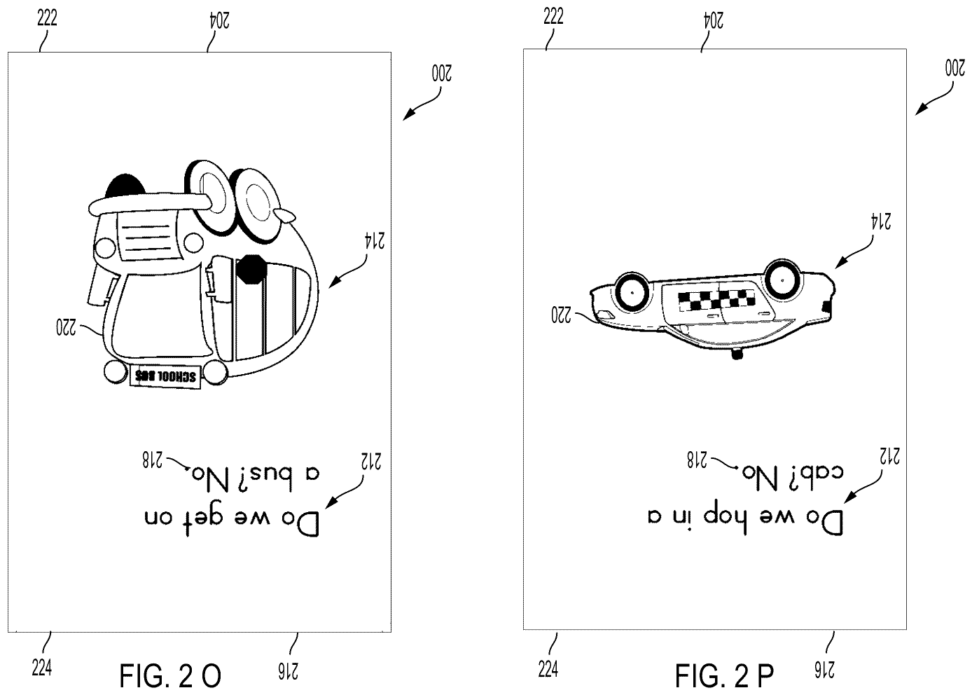

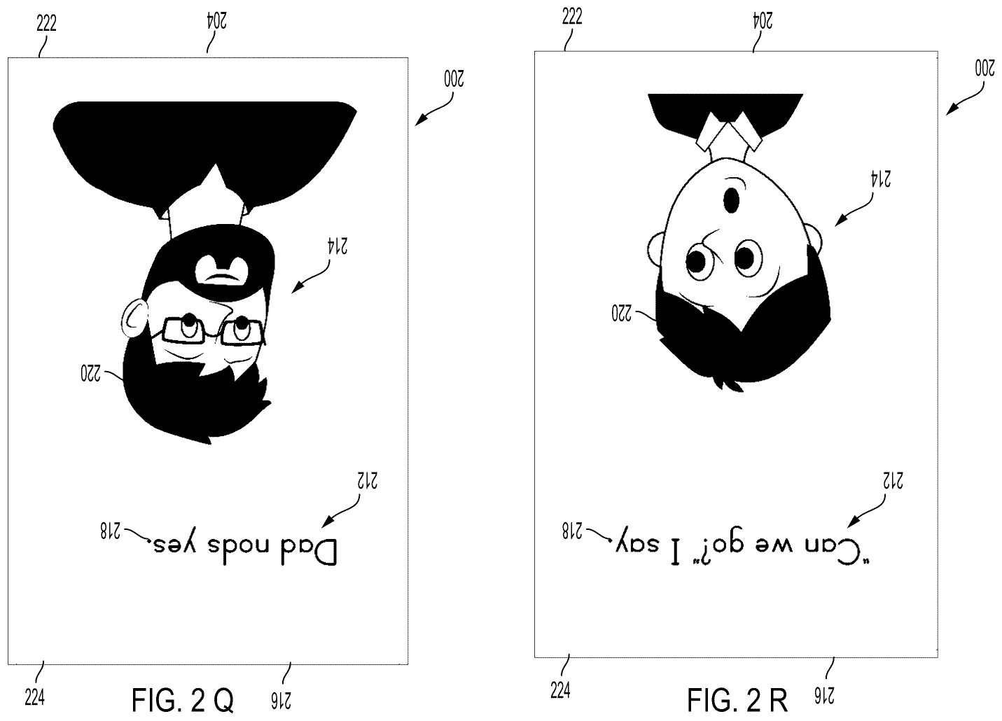

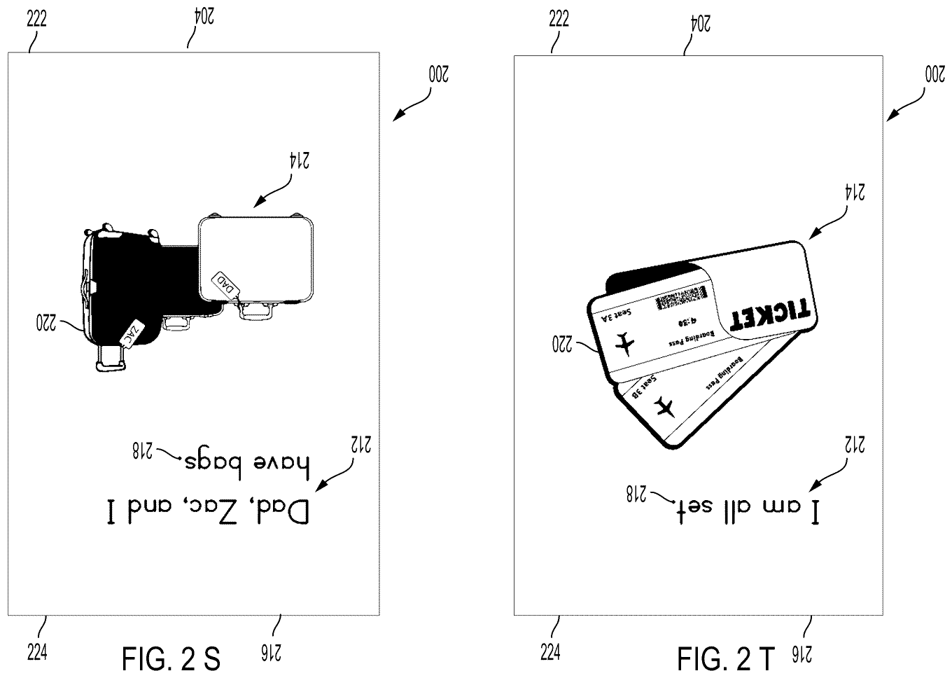

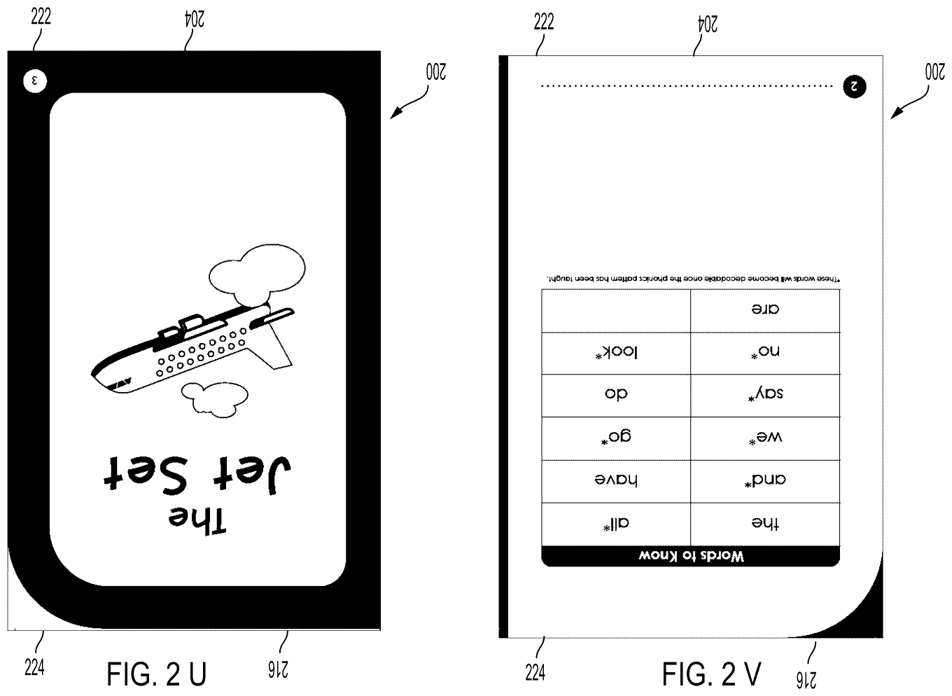

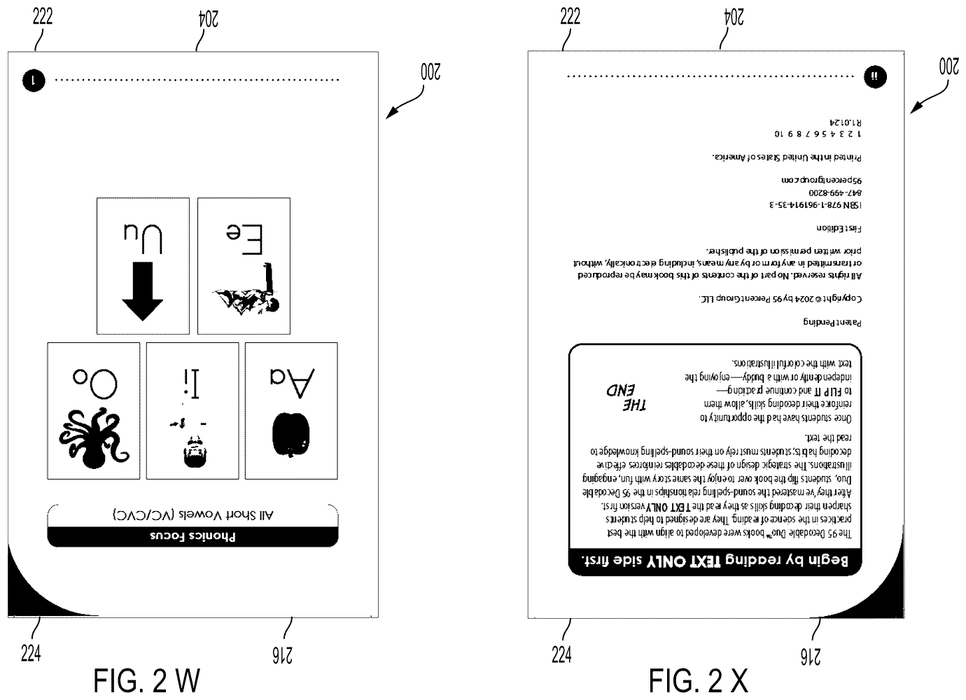

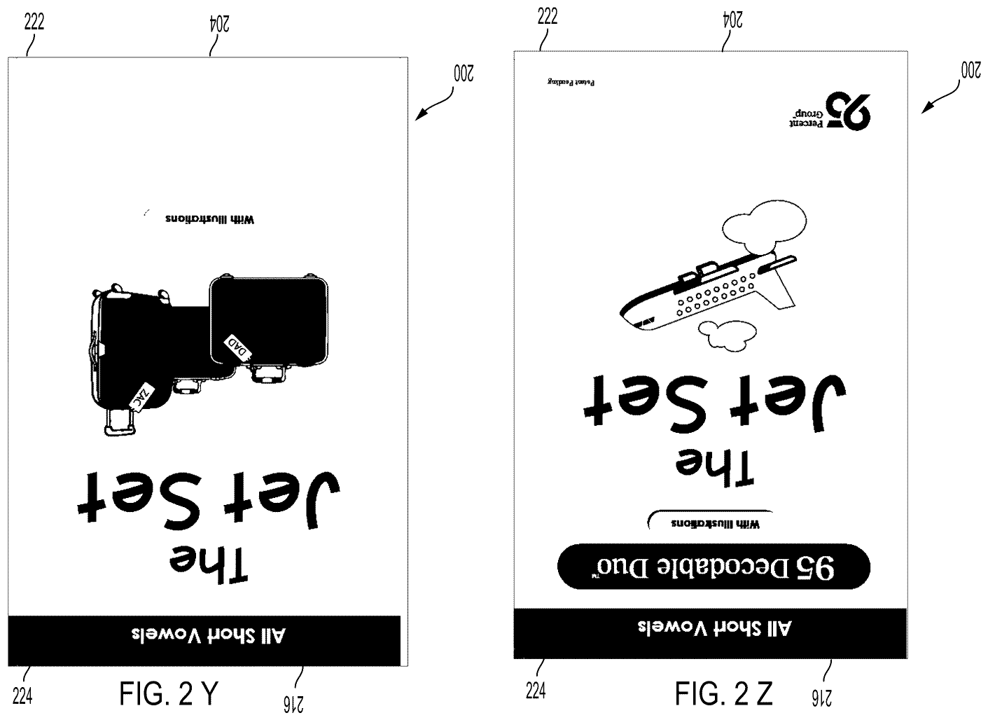

FIGS. 2A-2Z illustrate an example embodiment of a decodable book 200. Particularly, FIGS. 2A-2Z illustrate the interior of the book 200. The interior could be the interior of the book 100. The book 200 includes a plurality of pages illustrated through FIGS. 2A-2Z. The plurality of pages have a first configuration 202 and a second configuration 204. The plurality of pages may be fixed in a predetermined order. The plurality of pages may be made up of a first section of pages 208 and a second section of pages 216.

FIG. 2A illustrates an example cover of the book 200 directed toward the first configuration 202, which includes text only. The book 200 can be flipped over. FIG. 2Z illustrates an example cover of the book 200 directed toward the second configuration 204, which includes text and illustrations.

FIG. 2B illustrates the phonic skills that are focused on in the book 200.

FIG. 2C illustrates words that the reader should know.

FIG. 2D is a title page for the first configuration 202. As illustrated in FIGS. 2E through 2I, the first configuration 202 includes a first text portion 206. The first text portion 206 may be included in the first section of pages 208. In the predetermined order, the first text portion 206 is readable when the book 200 is in a first orientation 210, and the first section of pages 208 is readable in the first configuration 202.

FIG. 2J illustrates an example page at the end of the first section of pages 208 in the first configuration 202. The example page indicates that the book 200 should be flipped over into the second configuration 204 to access a second text portion 212 and an illustrated portion 214. The second text portion 212 and the illustrated portion 214 may be included in the second section of pages 216. The second section of pages 216 and the second text portion 212 and the illustrated portion 214 may be readable in the second configuration 204.

Once the book 200 is flipped over into the second configuration 204, FIG. 2Z illustrates an example cover of the book 200 directed toward the second configuration 204.

FIG. 2Y illustrates a title page for the second section of pages 216.

FIG. 2X illustrates an instruction page for the book 200, which states to start with the first section of pages 208 first.

FIG. 2W illustrates the phonic skills that are focused on in the book 200.

FIG. 2V illustrates words that the reader should know.

FIG. 2U is a title page for the second configuration 204. As illustrated in FIGS. 2K through 2T, the second configuration 204 includes the second text portion 212. The second text portion 212 and illustrated portion 214 are readable when the book is in the second orientation 204.

As illustrated in FIGS. 2K through 2T, the second text portion 212 can include a plurality of sentences 218 and the illustrated portion 214 can include a plurality of illustrations 220. Each illustration in the plurality of illustrations 220 corresponds to at least one sentence in the plurality of sentences 218. In other words, each illustration in the plurality of illustrations 220 conveys an image, and the image is based on the corresponding at least one sentence in the plurality of sentences 218.

In some embodiments, the book 200 includes a first edge 222 and a second edge 224, wherein in the first orientation 210 the first edge 222 is at a distal portion from a reader and the second edge 224 is at a proximal position from the reader.

In some embodiments, in the second orientation 212 the first edge 222 is at a proximal position from the reader and the second edge 224 is at a distal position from the reader. In some embodiments, the proximal position is near the reader and the distal position is away from the reader.

As illustrated through FIGS. 2A through 2Z, the first text portion 206 is the same as the second text portion 212. The first text portion 206 and the second text portion 212 can be a story. The story can have a word count from 25 to 175 words. Because the second section of pages 216 includes the second text portion 212 and the illustrated portion 214, a number of pages in the second section of pages 216 may be greater than a number of pages in the first section of pages 208, which only includes the first text portion 206 but no illustrations.

In an example embodiment, the first section of pages 208 and the second section of pages 216 are bound together. In some embodiments, the bound edge includes a glue-based binding, a plurality of rings, a sewn binding, and/or a stapled binding. In some embodiments, the pages may be removable from the bound edge such that the pages can be arranged in various orders.

In some embodiments, the book may be a booklet, a binder, bound pages, a pamphlet, or any other reading material. In some embodiments, the book further includes a soft cover, a hard cover, or a paper cover.

In an example embodiment, the first text portion and the second text portion are made of decodable text, as previously described in paragraph [0044]. In the book 200, the decodable text can include a vowel (“V”) sound in various configurations with consonant (“C”) sounds.

In some embodiments, a method for using a decodable reversible book is disclosed. The method includes positioning the book in a first orientation, reading the book in the first orientation, positioning the book in a second orientation, and reading the book in the second orientation. In some embodiments, the book includes a decodable story with text and illustrations, as well as a decodable story with text only. The decodable story with text only is accessible by positioning the book in a first orientation. The decodable story with text and illustrations is accessible by positioning the book in a second orientation. The disclosed book is designed to help students sharpen their decoding skills by reading the book in the first orientation before reading in the second orientation. By reading the book in the first orientation before reading in the second orientation, the student reinforces effective decoding skills for at least the reason that the student can rely on sound-spelling knowledge to read the text without illustrations.

The detailed description above describes various features and operations of the disclosed book and methods with reference to the accompanying figures. The illustrative implementations described herein are not meant to be limiting. Certain aspects of the disclosed book and method can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

1. A book comprising:
a plurality of pages, having a first configuration and a second configuration, wherein in the first configuration the plurality of pages comprises a first text portion and in the second configuration the plurality of pages comprises a second text portion and an illustrated portion; and
a bound edge fixing the plurality of pages in a predetermined order, wherein in the predetermined order the first text portion is readable when the book is in a first orientation and the second text portion and illustrated portion are readable when the book is in a second orientation;
wherein the first text portion and the second text portion comprise decodable text.

2. The book of claim 1, further comprising a first edge and a second edge, wherein in the first orientation the first edge is at a distal position from a reader and the second edge is at a proximal position from the reader.

3. The book of claim 2, wherein in the second orientation the first edge is at a proximal position from the reader and the second edge is at a distal position from the reader.

4. The book of claim 1, wherein the first text portion is the same as the second text portion, and wherein the first text portion and the second text portion comprise a story.

5. The book of claim 4, wherein the story comprises a word count, wherein the word count is 25 to 175 words.

6. The book of claim 1, wherein the second text portion comprises a plurality of sentences, and wherein the illustrated portion comprises a plurality of illustrations, wherein each illustration in the plurality of illustrations corresponds to at least one sentence in the plurality of sentences.

7. The book of claim 6, wherein each illustration in the plurality of illustrations conveys an image, and wherein the image is based on the corresponding at least one sentence in the plurality of sentences.

8. The book of claim 1, wherein the plurality of pages comprises a first section of pages and a second section of pages, wherein the first section of pages comprises the first text portion, and wherein the second section of pages comprises the second text portion and the illustrated portion.

9. The book of claim 8, wherein the first section of pages is readable in the first configuration, and wherein the second section of pages is readable in the second configuration.

10. The book of claim 8, wherein a number of pages in the first section of pages is less than a number of pages in the second section of pages.

11. The book of claim 8, wherein the first section of pages and the second section of pages are bound together.

12. The book of claim 1, wherein decodable text comprises a vowel (“V”) sound in various configurations with consonant (“C”) sounds.

13. A system comprising:
a plurality of books, wherein each book in the plurality of books comprises:
a plurality of pages, having a first configuration and a second configuration, wherein in the first configuration the plurality of pages comprises a first text portion and in the second configuration the plurality of pages comprises a second text portion and an illustrated portion; and
a bound edge fixing the plurality of pages in a predetermined order, wherein in the predetermined order the first text portion is readable when the book is in a first orientation and the second text portion and illustrated portion is readable when the book is in a second orientation;
wherein the first text portion and the second text portion comprise decodable text.

14. The system of claim 13, wherein the first text portion, the second text portion, and the illustrated portion in each of the plurality of books are different from each other the other books in the plurality of books.

15. The system of claim 13, wherein each book in the plurality of books further comprises a first edge and a second edge, wherein in the first orientation the first edge is at a distal position from a reader and the second edge is at a proximal position from the reader.

16. The system of claim 15, wherein in the second orientation the first edge is at a proximal position from the reader and the second edge is at a distal position from the reader.

17. The system of claim 15, wherein in each book in the plurality of books the first text portion is the same as the second text portion, and wherein the first text portion and the second text portion comprise a story.

18. The system of claim 17, wherein the story comprises a word count, wherein the word count is 25 to 175 words.

19. The system of claim 13, wherein in each book in the plurality of books the second text portion comprises a plurality of sentences, and wherein the illustrated portion comprises a plurality of illustrations, wherein each illustration in the plurality of illustrations corresponds to at least one sentence in the plurality of sentences.

20. The system of claim 13, wherein in each book in the plurality of books the plurality of pages comprises a first section of pages and a second section of pages, wherein the first section of pages comprises the first text portion, and wherein the second section of pages comprises the second text portion and the illustrated portion.
